(19) United States
(12) Patent Application Publication
(10) Pub. No.: US 2013/0055327 A1
(43) Pub. Date: Feb. 28, 2013

(54) MAPPING WEB CONTENT TO UNUSED BROADCAST CHANNEL

(71) Applicant: Praphul Chandra, Bangalore (IN)

(72) Inventor: Praphul Chandra, Bangalore (IN)

(21) Appl. No.: 13/596,863

(22) Filed: Aug. 28, 2012

(30) Foreign Application Priority Data
Aug. 29, 2011 (IN) 2979/CHE/2011

(51) Int. Cl. H04N 21/20

(52) U.S. Cl. 725/109

(57) ABSTRACT

Provided is a method of mapping web content to an unused broadcast channel. The method detects an unused broadcast channel, maps web content to the unused broadcast channel and displays web content through the unused broadcast channel.

### CLAIM FOR PRIORITY

The present application claims priority under 35 U.S.C 119 (a)-(d) to Indian Patent application number 2979/CHE/2011, filed on Aug. 29, 2011, which is incorporated by reference herein in its entirety.

### BACKGROUND

Television users are familiar with the concept of channels. In broadcasting terminology, a channel represents content (audio, video or both) transmitted by a content provider (broadcaster) to an audience. Each channel is transmitted over a particular radio frequency (virtual channel). A receiver decodes a channel's broadcast content and maps it to a channel name or number on user's device (television set, set-top box, etc.). The user is simply required to select a channel number or name to view associated content.

The number of channels available to a user for viewing have increased manifold over the years. Since a user is spoilt for choice, channel flipping is a common practice for a user to select a channel of his or her choice. However, during a selection process a user often encounters an unused channel which has not been mapped to any broadcast content. In fact, there could be multiple unused channels which are not tuned to a broadcast station. There is very little that a user could do with such unused channels and, sometimes, they may act as irritants to overall user experience.

### BRIEF DESCRIPTION OF THE DRAWINGS

For a better understanding of the solution, embodiments will now be described, purely by way of example, with reference to the accompanying drawings, in which:

FIG. 1 shows a flow chart of a method of mapping web content to an unused broadcast channel, according to an embodiment.

FIG. 2 shows a block diagram of a system for mapping web content to an unused broadcast channel, according to an embodiment.

### DETAILED DESCRIPTION OF THE INVENTION

Television viewing is typically about watching content of one's choice. A wide variety of content, from entertainment to edutainment, is available for a user's enjoyment. All that is needed is for a user to select a channel number or name of his or her choice. However, with multitude of channels available now days it becomes difficult for an individual to remember and recall more than a handful of channel names or numbers. As a result, a user frequently resorts to channel flipping to select a channel of his choice. Often, the selection process is marred by appearance of an unused channel which has not been mapped to any broadcast content. From a user experience perspective, this is not a desirable situation. It would be useful if the unused broadcast channel could be used more productively.

In addition to broadcast content, an internet savvy user is also familiar with web content (accessible through the internet). It is typical to find people, especially youth, regularly consuming web content (such as video, audio, text, etc.) on their personal devices, such as touchpad, personal computer and mobile devices. Since web content is typically viewed with the help of a web browser, it becomes tedious when a user wants to alternate between web content and broadcast content (typically delivered and accessed over a broadcast channel format). The user interaction paradigm for consuming broadcast content and content from the World Wide Web is fundamentally distinct. In a scenario where a user may want to access content from both broadcast and web, it would be useful to have a solution where the user may maintain a single interaction paradigm of channels without needing to worry about which media (broadcast or web) the content is coming from.

Embodiments of the present solution provide a method and system for mapping web content to an unused broadcast channel.

### Definition of Terms

The term “web content”, in this document, may include textual, visual or audio content that is encountered as part of the user experience on World Wide Web (WWW). It may include, among other things, text, images, sounds, videos and animations. It may also include computer applications, such as tasklets. A tasklet includes a series of task based transactions (web or non-web based) bundled together in the form of a module or an application. The tasks may include, to provide a few non-limiting examples, payment of a utility bill, purchasing an airline ticket, booking a cab, checking into a hotel, etc. Tasklets could be run on a user's device or on the web (for example, in a cloud environment). [Tasklets have been described in detail, in the commonly assigned PCT application serial no. PCT/IN2009/000327, titled “System and method for representing user interaction with a web service”, filed on Jun. 5, 2009]. Web content may also include web channels. [Concept of web channels is described in detail, in the commonly assigned patent application titled “Personalized Video Retrieval”, U.S. patent application Ser. No. 12/754,633, filed on Apr. 6, 2010]. Web content may further include messages based on or linked to a social networking site (for instance, twitter messages).

The term “broadcast channel” may include a range of frequencies (or, equivalently, wavelengths) assigned by an agency to a broadcaster for transmission of broadcast content. The term also may be used to refer to the station or channel, on a device, operating on a particular frequency.

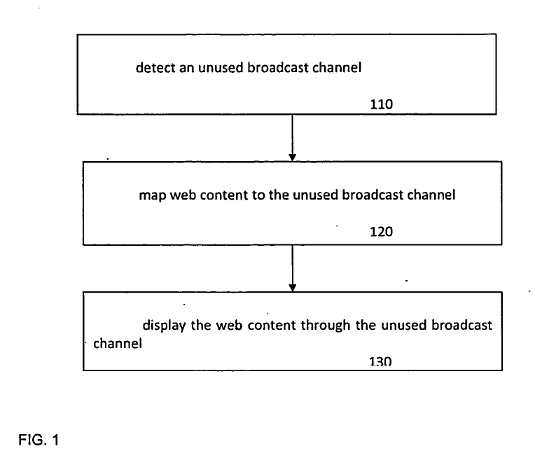

FIG. 1 shows a flow chart of a method of mapping web content to an unused broadcast channel, according to an embodiment.

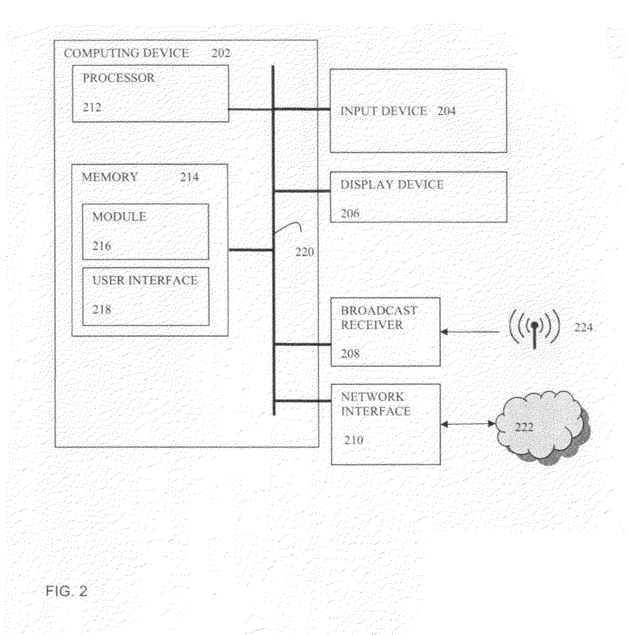

The method may be implemented on a computing device (system), such as, but not limited to, a personal computer, a desktop computer, a laptop computer, a notebook computer, a network computer, a personal digital assistant (PDA), a mobile device, a hand-held device, a television (TV), and the like. The computing device may be connected to a broadcast network and/or a computer network, such as, an intranet or the internet (World Wide Web). A typical system that may be used is described further in detail subsequently with reference to FIG. 2.

Additionally, the computing device may be connected to another computing device or a plurality of computing devices via a network, such as, but not limited to, a Local Area Network (LAN), a Wide Area Network, the Internet, or the like.

Referring to FIG. 1, in block 110, the proposed method detects an unused or untuned broadcast channel. An unused broadcast channel on a system is the one which at a particular time is not displaying any broadcast content. It is assumed that proposed solution is implemented in a system which is capable of receiving, decoding and displaying broadcast content via broadcast channels. The implementing system may be further capable of receiving web content (via the internet.). In an example, receiving, decoding and displaying of broadcast content and web content may performed by a single system (device). In other examples, however, these tasks may be distributed across a plurality of devices, which may be connected to each other via wired or wireless means.

In an example, an unused broadcast channel is automatically recognized. An application scans the broadcast channels being received by a system and determines whether there is/are unused broadcast channel(s).

In another example, a user's attempt to tune an unused broadcast channel on a system is recognized. The user's intent may be acknowledged in a number of ways.

In an instance, a user may provide an explicit input to the system indicating his desire to tune an unused channel. An explicit input may be provided by first selecting an unused channel number on the system. This may be done by either directly providing the channel number to the system, if the user is already familiar with the unused channel number, or by flipping to the unused channel number. Once an unused channel is selected, a user may issue a command (for example, by a hardware key press, voice, touch, gesture, etc.) to the system indicating his desire to tune the channel.

In another instance, implicit user input may be used to recognize a user's attempt to tune an unused broadcast channel number. In this scenario, a user may first select an unused channel and then pause for a pre-defined time period before providing another input. The system recognizes the user's pause (for a pre-defined time period) as his intent to tune the unused channel.

In either of the above mentioned scenarios, a user's attempt to tune an unused channel (or channel number) is captured by the system.

Block 120 involves mapping of web content to an unused channel selected in block 110. As defined earlier, web content may include, inter alia, text, audio and/or video. It may also include applications (machine executable code), such as, tasklets.

Mapping of web content to an unused channel may take place at the instance of a user or automatically by the system.

In an embodiment, a user may specify or select web content which is to be mapped to an unused channel number on the system. The web content may be selected by first downloading the content from the internet and then mapping it to the unused channel. The web content may be downloaded and stored on the system or a storage medium removably attachable to the system (such as, a portable hard disk drive, a pen drive, a compact disc, a digital video disc, and the like). The user could create a collection of related web content and, later, map it to an unused channel. Previously downloaded web content may also be mapped to an unused web channel.

To provide an illustration, a user may download a selection of music videos from the internet and then map the collection to an unused channel. In another illustration, a user may download and create a compilation of food recipes on the system and subsequently map it to an unused broadcast channel of his or her choice.

In another instance, the web content may be a collection of different media (such as, text, audio and/or video). To illustrate, a user may build a collection of different media on railway engines (articles, white papers, audio clips of engine sounds, engine videos, etc.) and map the collection to an unused channel.

In another example, the web content may correspond to a group of related key words. A user may specify a collection of key words in advance, which is then mapped to an unused broadcast channel. For example, a user may specify terms like “HP”, “Inkjet” and “printer” in combination and link them to an unused channel. Upon subsequent selection of the “previously” unused channel, the system downloads all relevant web content related to these keywords and displays them to the user.

A user could also map an application of user's choice to an unused broadcast channel. In an instance, the application could be a tasklet. To provide an illustration, a tasklet related to payment of a utility bill or purchase of an airline ticket may be mapped to an unused channel. The tasklet could be stored on the system or an attachable storage medium.

In an instance, once the system recognizes a user's attempt to tune an unused broadcast channel (block 110), a user interface (for instance, a graphical user interface (GUI)) may be displayed on the system, for a user to select and map web content of user's choice to an unused broadcast channel.

The web content mapped to an unused channel number may remain associated with the channel until it is explicitly removed or remapped.

In another embodiment, mapping of web content to an unused broadcast channel could be automatically carried out by the system with minimum or no user input. The system may keep track of a user's online activities (for instance, web sites visited by a user, web content viewed by a user, etc.) and based on such interaction dynamically builds a collection of relevant web content for user's consumption. The collection is later mapped to an unused broadcast channel. To illustrate, if a user had been visiting web sites related to HP touch pads, the system would dynamically capture related web content and map it to an unused channel for user's consumption. The content may be dynamically updated periodically based on user's recent web interaction and mapped to a channel. So each time a user attempts to tune to a “previously” unused channel, the system displays most recent and updated web content based on user context and interaction.

In another example, a system may automatically map web content to an unused broadcast channel based on content or information related to a nearby or neighborhood channel(s). A neighborhood channel may be system or user defined. For instance, a neighborhood channel may include a channel preceding or anteceding a channel (in the present context, an unused channel). It may also mean to include any other user defined channel. To provide some examples: (a) if channel number 50 is being used for broadcasting a live cricket match, and channel number 51 is unused in the broadcast domain, channel 51 may be termed a neighborhood channel. (b) if channel number 50 is being used for broadcasting a live cricket match, and channel number 500 is unused in the broadcast domain, channel 500 may be termed a neighborhood channel, if so defined by a user.

In the above example, the system may use an electronic program guide (EPG), which is typically made available by a broadcaster to provide program content related information, to obtain details related to a nearby or neighborhood channel(s). In another instance, the information related to nearby or neighborhood channels may be obtained from a website (for example, maintained by a broadcaster) containing such information. The information obtained may relate to the metadata associated with the program content (title of the program, keywords etc.) of a neighborhood channel. The metadata is then used to determine and map related web content to the unused channel. To provide an illustration, if channel number 50 is being used for broadcasting a live cricket match, and channel number 51 is unused in the broadcast domain, channel 51 may be used to pull cricket-related videos from the web.

In an example, detection of unused channels and mapping of these unused channels to web content may be done by a single device. In other examples, however, these tasks may be distributed across a plurality of devices, which may be connected to each other via wired or wireless means. For example, detection of un-used channels may be done by the set-top box but mapping these unused channels to web content may be done by another device.

In block 130, web content mapped to an unused broadcast channel is displayed via the unused broadcast channel. The mapped web content is presented on a display connected (removably or non-removably) to the system. For example, considering the railway engine illustration mentioned above, text articles, audio and video clips may be presented on the unused broadcast channel for a user's consumption.

The proposed disclosure enables automatic switching in the system for a display to accept content from a web-connected system when an unused channel number is selected and switching it back to accept content from the broadcast receiver when a valid (in-use) channel number is selected.

FIG. 2 shows a block diagram of a system 200 for mapping web content to an unused broadcast channel, according to an embodiment.

The system 200 includes a computing device 202, an input device 204, a display device 206, a broadcast receiver 208 and a network interface 210. The input device 202, display device 206 and broadcast receiver 208 may be distinct devices, which may be removably attached to the computing device 202, or they may be integrated with the computing device 202. The computing device 202 may communicate with the input device 204, display device 206 and broadcast receiver 208 by wired or wireless means.

The computing device 202, may be, but not limited to, a television (TV) set, a personal computer, a desktop computer, a laptop computer, a notebook computer, a network computer, a personal digital assistant (PDA), a mobile device, a hand-held device, or the like.

The computing device 202 may include a processor 212, for executing machine readable instructions, a memory (storage medium) 214, for storing machine readable instructions (such as, module 216 and user interface 218), and a network interface 210. These components may be coupled together through a system bus 220. In an example, display device 206, broadcast receiver 208 and network interface 210 are present together in a single computing device (unit).

Processor 212 is arranged to execute machine readable instructions. The machine readable instructions may be in the form of a module 210 or an application for executing a number of processes. In an example, the module detects an unused broadcast channel(s) in the computing device and passes that information to processor 212. Processor 212, in turn, upon detection of an unused broadcast channel, instructs a computer application (machine readable instructions) to map web content to an unused broadcast channel.

It is clarified that the term “module”, as used herein, means, but is not limited to, a software or hardware component. A module may include, by way of example, components, such as software components, processes, functions, attributes, procedures, drivers, firmware, data, databases, and data structures. The module may reside on a volatile or non-volatile storage medium and configured to interact with a processor of a computer system.

The memory 212 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 214 may include a module 216 and a user interface 218. The memory 214 may further include a computer application(s) (not shown in FIG. 2). The user interface 218 may be a graphical user interface (GUI), which may be displayed on the system, for a user to select and map web content of user's choice to an unused broadcast channel. In an example, the GUI is displayed once the system recognizes a user's attempt to tune an unused broadcast channel.

The display device 206 may include a Virtual Display Unit (VDU) to display, inter alia, the graphical user interface (GUI) 218, an unused broadcast channel(s) and unused broadcast channel(s) with mapped web content.

Network interface 210 may act as a communication interface between computing device 202 and the Internet (or WWW) 222. The interface 210 enables the device 202 to access and download web content.

Broadcast receiver 224 may act as a communication interface between computing device 202 and a broadcast network (broadcast channel provider) 224. The broadcast receiver 224 enables the device 202 to receive broadcast channels (broadcast content) from a broadcast channel provider 224

Input device 204 may be used to receive a user input to map web content to an unused broadcast channel. The input device may receive a user input in the form of a touch input, a voice input, a gesture input or a hardware-based input through a key press (for example, through a remote control device), etc.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of mapping web content to an unused broadcast channel, comprising:
detecting an unused broadcast channel;
mapping web content to the unused broadcast channel; and
displaying the web content through the unused broadcast channel.

2. A method according to claim 1, wherein the web content is used defined.

3. A method according to claim 1, wherein the web content is based on information collected by analyzing a user's online activities.

4. A method according to claim 1, wherein the web content is regularly updated based on the user's online activities.

5. A method according to claim 1, wherein the web content is based on content of a neighborhood channel.

6. A method according to claim 1, wherein detection of an unused broadcast occurs upon recognition of a user input related to the unused broadcast channel.

7. A method according to claim 1, further comprising displaying a graphical user interface enabling a user to map user selected web content to the unused broadcast channel.

8. A method according to claim 1, wherein the web content includes text, image, audio, video and/or multimedia.

9. A method according to claim 1, wherein the web content includes a computer application.

10. A method according to claim 1, wherein the web content includes messages based on a social networking site.

11. A system comprising:
a module, in a memory, to detect an unused broadcast channel;
a processor which, upon detection of an unused broadcast channel, instructs to an application to map web content to the unused broadcast channel; and
a display device that displays the web content through the unused broadcast channel.

12. The system of claim 11, further comprising:
a broadcast receiver to receive broadcast channels; and
a network interface to receive web content.

13. The system of claim 11, further comprising a graphical user interface (GUI) to enable a user to map user selected web content to the unused broadcast channel.

14. The system of claim 11, wherein the web content is used defined.

15. An apparatus comprising:
a computer readable medium comprising instructions: to detect an unused broadcast channel, to map web content to the unused broadcast channel and to display the web content through the unused broadcast channel.
